(19) United States
(12) Patent Application Publication
(10) Pub. No.: US 2004/0175454 A1
(43) Pub. Date: Sep. 9, 2004

(54) Devices and methods for maximizing purge effectiveness for molding machines

(76) Inventor: Joel Thomson, Elka Park, NY (US)

Correspondence Address: Richard S. Milner, Cooper & Dunham LLP, 1185 Avenue of the Americas, New York, NY, 10036, US

(21) Appl. No.: 10/764,760

(22) Filed: Jan. 26, 2004

Related U.S. Application Data
(60) Provisional application No. 60/442,960, filed on Jan. 27, 2003.
(60) Provisional application No. 60/457,124, filed on Mar. 24, 2003.

(51) Int. Cl. B29C 45/20

(52) U.S. Cl. 425/574

(57) ABSTRACT

Methods and devices for cleaning the screw and barrel of a reciprocating screw injection molding machine using a purging/cleaning compound and a non-return valve that can be held open during the purging/cleaning cycle to allow bi-directional flow of the purging/cleaning compound.

This application claims the benefit of U.S. Provisional Application No. 60/442,960 filed Jan. 27, 2003 and the benefit of U.S. Provisional Application No. 60/457,124 filed Mar. 24, 2003.

### FIELD OF THE INVENTION

The present invention relates to devices and methods for purging and/or cleaning injection molding machines by providing for multiple passes of a purging and/or cleaning material through the machine.

### BACKGROUND OF THE INVENTION

Conventional injection molding machines contain a screw which rotates inside a heated barrel to melt and accumulate plastic material and then moves axially to inject that material into a mold. One-way flow is enforced by a check valve attached to the downstream end of the screw, enabling the screw to function as a piston during injection.

Purging such conventional injection molding machinery typically consists of passing a neutral material through the barrel to expel one plastic material or color in preparation for a different one. Abrasive, detergent, or chemical characteristics of conventional cleaning materials aid in the release of contamination from the screw and barrel. However, these conventional procedures are often inadequate to clean the machinery unless large quantities of such compounds are used. Furthermore, the conventional compounds often provide insufficient cleaning action, and the machine must be disassembled and manually cleaned.

Throughout this disclosure references to ‘purging materials’, ‘cleaning materials’, ‘purging compounds’ and ‘cleaning compounds’ are used interchangeably and should be understood to mean materials and/or compounds which are used to purge and/or clean. Similarly, the references ‘cleaning’ and ‘purging’ are also used interchangeably and refer to one or the other or both.

Although a purging material acts to displace contamination from screw flights and to mechanically scrub such contamination from metal surfaces, the mechanical action for conventional purging is limited because the material passes through the system only once and in only a single direction.

In addition, many purging compounds rely on chemical action to break down cross-linked or carbonized deposits. These compounds typically rely on a “soak” time wherein the compound is left sitting in the stationary screw for a number of minutes to allow the chemical reaction to proceed despite the fact that chemical reactions proceed faster with agitation, particularly when the reagents are solid or high-viscosity fluids.

In addition, the flow of resin or purging material through a screw is only as fast as the shear flow in the screw flights.

Furthermore, purging compounds are most effective under heat and pressure. However, in conventional purging, the part of the screw upstream of the compression zone provides little melting, mixing, and compression, so pellets of unmelted purging material do not pick up contamination (previous melt material) from this area.

Also, purging compounds are usually very viscous, or even contain non-melting solid particles. This characteristic can cause problems getting the compound itself out of the barrel when switching to a new resin.

Thus, a need exists for improved methods and devices for cleaning/purging injection molding machines which overcome at least the limitations discussed above.

### SUMMARY OF THE INVENTION

One object of the present invention is to provide a check valve which is designed to be selectively disabled, either manually or via an automatic process, to cause a quantity of cleaning compound to flow back through the check valve into the flights of the screw using the standard injection stroke of the screw. This bi-directional flow of material can be repeated as many times as necessary thereby performing scrubbing, polishing, and cleaning of the screw flights without introduction of additional compound.

Another object of the present invention is to provide an extended time period over which the compound is maintained in an agitated condition.

A further object of the present invention is to provide faster flow than conventional techniques under higher pressure which increases the mechanical scrubbing action needed to clean the screw and barrel.

An additional object of the present invention is to provide a mechanism for breaking down the viscosity of the purging compound and/or the size of abrasive particles contained therein, through time and heat and chemical depolymerization so as to facilitate displacement by the next resin used in the machine.

Another object of the present invention is to provide a way to get fully melted compound all the way back through the transition area of the barrel.

An additional object of the present invention is to provide an apparatus for a reciprocating screw injection molding machinery having a barrel and a screw which rotates in the barrel, and a check valve having means to selectively switch to a first mode which allows bi-directional flow of material along the screw. This apparatus can also provide: (1) means for switching the check valve between the first mode and a second mode which prevents bi-directional flow of material along the screw; (2) means for switching the check valve between the first and second modes by axial motion of the screw; (3) means for switching the check valve between the first and second modes by rotational motion of the screw; (4) means for at least partially blocking the egress of the material from the barrel; and/or (5) means for attaching the check valve to the screw.

In addition, the present invention provides for a cleaning compound which can include: (1) an abrasive; (2) a detergent; (3) materials which cause the cleaning compound to have a rheopectic flow behavior; (4) materials which cause the viscosity of the cleaning compound to decrease during agitation; (5) materials which release carbon dioxide when heated or agitated; (6) materials which release water when heated or agitated; and/or (7) materials having particles for polishing the barrel and the screw.

Further, the present invention provides a check valve having a body having a protrusion, a sliding ring having a slot, and a valve seat, such that the first mode occurs when the protrusion moves into a bottom of the slot. Also, the check valve can be a ring-type check valve, a poppet-type check valve, or a ball-type check valve.

Another object of the present invention is to provide a method of allowing bi-directional flow in reciprocating screw injection molding machines having a barrel and screw which rotates in the barrel having the steps of: (1) moving the screw in a rotational direction to allow material to flow in a first axial direction; (2) moving the screw in a second axial direction to lock a check valve; (3) moving the screw in the first axial direction to cause the material to flow in the second axial direction; and (4) moving the screw in the rotational direction to unlock the check valve and allow material to flow in the first axial direction. The method can also provide that the second, third, and fourth moving steps are repeated multiple times.

A further object of the present invention is to provide a method of cleaning reciprocating screw injection molding machines having a barrel and screw which rotates in the barrel which has the steps of: (1) displacing residual melt in screw flights of the screw with a cleaning compound; (2) accumulating a quantity of the cleaning compound ahead of the screw; (3) blocking an exit for the cleaning compound from the barrel; (4) moving the screw in a forward axial motion to cause the cleaning compound to travel back into the screw flights; (5) at least partially opening the exit; and (6) expelling the cleaning compound. In addition this method can also include the step of accumulating a quantity of the cleaning compound ahead of the screw, and/or the repetition of the moving and second accumulating steps multiple times.

### BRIEF DESCRIPTION OF THE DRAWINGS

FIG. 1 is partial cross-sectional view illustrating a check valve in the unlocked position according to one embodiment of the invention;

FIG. 2 is a partial cross-sectional view illustrating the check valve of FIG. 1 in the locked position;

FIG. 3 is a diagrammatic view illustrating a ring-type check valve in the locked position according to one embodiment of the invention;

FIG. 4 is a diagrammatic view illustrating a poppet-type check valve in the locked position according to one embodiment of the invention; and

FIG. 5 is a diagrammatic view illustrating a ball-type check valve in the locked position according to one embodiment of the invention.

### DETAILED DESCRIPTION OF THE INVENTION

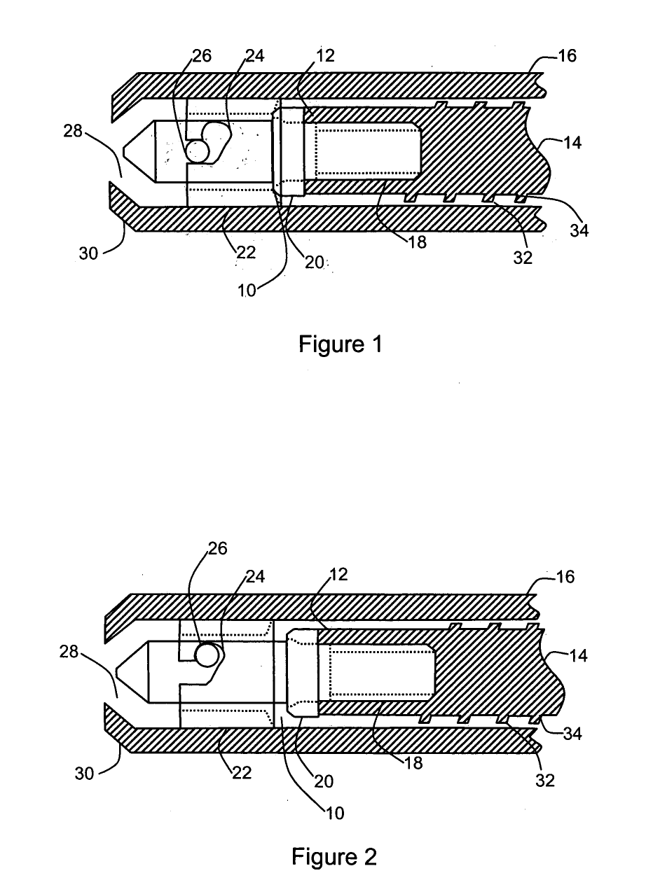

One embodiment of the present invention is shown in FIGS. 1 and 2. A check valve 10 is affixed to the downstream end 12 of an injection molding screw 14 housed within a barrel 16 which primarily has three components: a body 18, a valve seat 20 and a sliding ring 22. An important feature of the check valve 10 is the presence of one or more slots 24 guiding the motion of the sliding ring 22 by means of one or more protrusions 26 from the body 18 of the valve 10. The shape of the slot(s) 24 is such that during forward axial motion or normal (traditionally counterclockwise) screw rotation, the ring 22 is free to move against the seat 20 or a short distance away from it, respectively. However, a reverse rotation and/or a reverse axial motion of the screw 14 causes the protrusion 26 to rotate the ring 22 into a “locked” position wherein the ring 22 cannot seal against the seat 20. Once moved into this position, the valve 10 will remain locked open until normal counterclockwise rotation of the valve body 18 relative to the ring 22 releases the valve. Because many conventional screws can rotate only in one direction, but can move axially in both forward and backward directions, the ring 22 of this embodiment is particularly useful to convert the reverse axial motion of the screw 14 into a locking movement for the check valve 10.

During molding, the screw 14 is first rotated to convey melted polymer through the check valve 10 into an accumulation space 28 ahead of the check valve. As melt accumulates, the screw 14 is retracted to enlarge the accumulation space 28. When sufficient melt has been accumulated, the screw 14 is usually retracted without rotation by an additional distance sufficient to relieve pressure on the melt. This retraction, normally less than 0.25 times the screw diameter, is not sufficient to rotate the sliding ring 22 relative to the valve body 18.

During purging, the screw 14 is rotated while a quantity of cleaning compound is introduced into the machine hopper. Once the compound has displaced a majority of the residual material in the barrel 16, the nozzle 30 is blocked and a series of cleaning cycles are performed. The nozzle 30 can be blocked by holding the nozzle opening against a closed mold, by attaching a blocking cap, or by closing a conventional manual or automatic shut-off nozzle which is fairly common in the industry.

In each cleaning cycle, the screw 14 is first rotated to convey material forward through the check valve 10. The screw 14 is then retracted until the sliding ring 22 has moved on its cam (the angled rear face of the slot 24) into the locked position, a distance of approximately 0.5 times the screw diameter or greater. The screw 14 is then caused to move forward axially and the material accumulated in front of the check valve 10 is forced to flow back through the check valve and along the screw flights 32. This cleaning cycle is repeated a number of times causing material to flow back and forth and to scour the screw and valve surfaces until they are free of residue. The rotation of the screw 14 necessarily unlocks/releases check valve 10, which was locked by the previous cleaning cycle, so as to allow the one-way flow of material forward. Once the residue is freed from the surfaces and suspended in the cleaning compound, the nozzle is opened and the screw is cycled normally to purge the contaminated cleaning compound from the barrel 16.

This process can be performed manually by an operator from the molding machine's control panel. Alternatively, a specialized cleaning cycle can be programmed into the machine controller and repeated automatically for a predetermined time or number of cycles without further operator -intervention. Accordingly, for example, the following steps can be implemented: (1) introduce cleaning compound at the hopper; (2) cycle the screw 14 with an open nozzle 30 until cleaning compound appears at the nozzle; (3) block the nozzle by closing a mechanical shut-off nozzle or by moving the injection carriage axially until the nozzle is seated against a (closed) mold; (4) oscillate the cleaning compound a pre-determined number of times back and forth through the check valve 10 by alternately running the screw and moving the screw axially; (5) open the nozzle (or retract the injection carriage); and (6) run the screw to eject the compound. The entire process can be repeated multiple times if necessary.

When material is caused to flow backward along the screw flights 14, some material can leak back up the feed port or feed throat of the hopper and cool there, causing a solid blockage. However, if the amount of material (both cleaning compound and residual melt material) in the barrel 16 is restricted during purging to less than the amount required to totally fill the screw flights 32, or a small amount of material (approximately 1/10 the shot volume) is allowed to exit the machine nozzle with each stroke, a forward flow of material is maintained through the feed port into the barrel 16 preventing a solid blockage. If the molding machine has a shut-off nozzle, the small amount of material can exit the barrel 16 by pausing the forward stroke of the screw 14, opening the nozzle, continuing the stroke for a small portion of time, and then closing the nozzle thereby allowing only the fraction of material to exit the barrel. Alternatively, allowing the majority of material in the barrel 16 to exit the nozzle once every few strokes also prevents accumulation back into the hopper.

One advantage of this invention is that the purging procedure for molding machines is sped up. Because an injection stroke is typically much faster than a recovery stroke, each point on the screw 14 is scrubbed by more total volume of cleaning compound per unit time than is possible with a conventional procedure. Furthermore, every cycle of the screw 14 moves the compound past the surfaces twice, rather than once as is the case with conventional procedures.

Another advantage is that this invention does not interfere with the normal operation or durability of the molding machine at least because the screw 14 need not be removed for conventional cleaning with a wire brush, metal wool, or blowtorch, all of which can damage the screw.

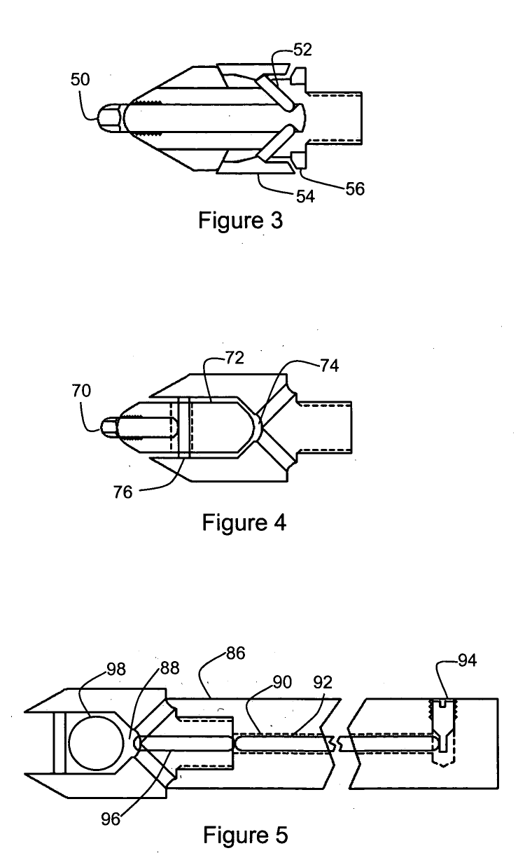

This invention also includes additional embodiments for check valves that can be selectively disabled as shown for example in FIGS. 3, 4, 5. While each of these embodiments are manually switched over between molding and cleaning modes, the present invention envisions the automation of these embodiments.

FIG. 3 illustrates a ring-type check valve in which a threaded stud 50 mounted in the end of a screw tip can be rotated so that stud moves axially. To close the check valve, the axially moving stud 50 pushes one or more pins 52 into a position to interfere with the normal closing action of the valve ring 54 against its fixed seat 56.

FIG. 4 illustrates a poppet-type check valve in which a similar threaded stud 70 is mounted in the center of the movable part or poppet 72 of the check valve. When the stud 70 is tightened against the rod or rods 76 that normally hold the poppet loosely in position, the poppet 72 becomes locked in the forward, open position.

FIG. 5 shows a ball-type check valve in which the body of the injection screw 86 is provided with an axial bore 90 extending substantially from the upstream (driven) end to the downstream (valve) end. The bore 90 houses a mechanical linkage 92 that transmits the motion of an adjustment stud 94 axially through the length of the screw 86 to the check valve 88. This motion is used to extend a pin 96 into a position where the pin interferes with the normal closing of the floating ball 98 of the check valve.

This invention also envisions other types of check valves, and particularly those check valves which can be prevented from closing by mechanical, electromechanical, or other stops.

While the embodiments described above will work with conventional purging compounds which are all apparently designed for one-pass use, for example, ASACLEAN Grade U (a trademark of Asahi Kasei Corp.), a special multi-pass compound that has special characteristics and/or changes characteristics over time is beneficial for use with the devices of the present invention.

One such characteristic for such a multi-pass compound can be provided by an abrasive solid that slowly breaks down or melts into a liquid when agitated. Longer polymer materials are good for displacing the residue polymers in molding machines because of their higher molecular weight and resistance to flow. However, such longer polymers are themselves hard to displace from the barrel. Accordingly, an abrasive solid which breaks down over time when subjected to the heat and shear in the barrel 16 is desirable. One such abrasive solid is an alkaline salt that, once melted by the heat and shear in the barrel, breaks down the longer polymer chains of both the cleaning compound's carrier resin and the surrounding organic residue on the screw 14. By breaking down the longer polymers into shorter polymers, the process advantageously reduces the molecular weight of the polymers and also the viscosity of the material in the barrel 16 during purging so that the purging compound will flow out of the barrel more easily when the cleaning is completed.

Another characteristic for a multi-pass compound is a purging compound that releases carbon dioxide when heated since dissolved carbon dioxide is a solvent for most plastic melts. The inclusion of a carbon dioxide releasing material in a purging compound of this invention especially facilitates cleaning because the high pressures generated in the barrel 16 and screw flights 32 using the processes of this invention cause the carbon dioxide to operate as a solvent, that is in the liquid phase, rather than as a non-solvent in the gas phase.

Another advantage of using a heat-released carbon dioxide material in purging compounds of this invention is to generate gas pressure since gas pressure increases the effectiveness of the compound's scrubbing action. In typical molding machine operations, the pressure is highest in the transition zone (also called compression zone), that is, the zone along the screw 14 between the feed zone where the flight depths are deeper to transport solid, un-melted pellets, and the metering zone where the flight depths are uniformly shallower. The transition zone is where most of the solid to liquid melt change occurs. However, the pressure usually decreases toward the downstream end 28 of the screw 14 and in the check valve 10. The present invention, in contrast, allows the generation of a steep reverse pressure profile with the highest pressure at the downstream end 28. This downstream end 28 is where the residual polymer has experienced the most heat history, and where the most discontinuities which generate low-flow or ‘dead’ spots are located in the flow path.

Water is another material which provides useful characteristics to a purging compound of this invention. Under high temperature and pressure, water is, a strong solvent, and also generates a pressurized gas phase. While liquid water is inconvenient if the purging compound is primarily a solid material, water is easily carried by hydrated salts or is absorbed in molecular sieve structures, for example silica gel. In both of these cases, the water is released as a cleaning agent when the purging compound is introduced into the heated pressure of the barrel 16.

During normal shear-induced flow along the screw flights 32, relative motion of the melt is highest at the barrel wall and lowest near the root 34 of the screw flights. Where melt moves the slowest, melt remains the longest and in the presence of barrel heat is subject to unwanted degradation or crosslinking. Accordingly, conventional purge procedures which provide additional shear-induced flow are also least effective where such shear flow is most needed: at the root 34 of the screw flights 32. In contrast, the present invention subjects the residue on the screw 14 to both shear flow, in the forward direction, and pressure (or plug) flow in the reverse direction. The reverse direction of material during pressure flow causes the velocity of the fluid to be the same on the root 34 of the screw flights 32 as on the barrel wall.

A key characteristic of a polymer liquid of the present invention is rheopectic (shear-thickening) behavior as opposed to the more common pseudoplastic (shear-thinning) property of most plastic melts. In the present invention a shear-thickening polymer compound more effectively scrubs the screw 14 while still being easy to displace from the barrel 16 under low shear conditions after purging. Rheopectic polymers (the best-known being the silicone-based fluid trade-named ‘Silly Putty’ from Dow-Corning Corp.) are usually characterized by a weak cross-linking between the polymer chains. While processes using such abrasive-filled viscous polymer liquids are know for grinding and polishing internal openings in metal parts, for example, a process called ABRASIVE FLOW MACHINING (a trademark of ExtrudeHone Inc. of Irwin, Pennsylvania), such processes are not believed to have been applied to screws during a purging process.

When an extrusion screw is new, it receives a high polish to facilitate flow and eliminate sticking. During use, this finish is lost due to wear and adhesion of polymers. On many used screws, accumulated polymer burns on to form a hard carbonized scale. Restoring the original surface polish is a useful function that can be performed with the current invention in addition to simple cleaning. Conventionally, restoring a screw's finish includes removing the screw for manual polishing or returning the screw to the manufacturer for machine polishing. Suitable size and hardness of abrasive particles suspended in the purging compound of this invention can facilitate an optimum polish without damaging the screw or barrel.

While the present invention has been described in terms of specific embodiments, this invention encompasses all variations and modification, including expedients by those skilled in the art, which come within the spirit of the specification and the scope of the appended claims.

What is claimed is:

1. An apparatus for a reciprocating screw injection molding machinery having a barrel and a screw which rotates in the barrel comprising:
a check valve having means to selectively switch to a first mode which allows bi-directional flow of material along the screw.

2. The apparatus according to claim 1 further comprising:
means for switching the check valve between the first mode and a second mode which prevents bi-directional flow of material along the screw.

3. The apparatus according to claim 1 further comprising:
means for switching the check valve between the first and second modes by axial motion of the screw.

4. The apparatus according to claim 1 further comprising:
means for switching the check valve between the first and second modes by rotational motion of the screw.

5. The apparatus according to claim 1 further comprising:
means for at least partially blocking the egress of the material from the barrel.

6. The apparatus according to claim 1 wherein the material comprises:
a cleaning compound.

7. The apparatus according to claim 6 wherein the cleaning compound comprises an abrasive.

8. The apparatus according to claim 6 wherein the cleaning compound comprises a detergent.

9. The apparatus according to claim 6 wherein the cleaning compound comprises materials which cause the cleaning compound to have a rheopectic flow behavior.

10. The apparatus according to claim 6 wherein the cleaning compound comprises materials which cause the viscosity of the cleaning compound to decrease during agitation.

11. The apparatus according to claim 6 wherein the cleaning compound comprises materials which release carbon dioxide when heated or agitated.

12. The apparatus according to claim 6 wherein the cleaning compound comprises materials which release water when heated or agitated.

13. The apparatus according to claim 6 wherein the cleaning compound comprises particles for polishing the barrel and the screw.

14. The apparatus according to claim 1 further comprising:
means for attaching the check valve to the screw.

15. The apparatus of claim 1 wherein the check valve comprises:
a body having a protrusion;
a sliding ring having a slot; and
a valve seat;
such that the first mode occurs when the protrusion moves into a bottom of the slot.

15. The apparatus according to claim 1 wherein the check valve is selected from the group consisting of: a ring-type check valve, a poppet-type check valve, and a ball-type check valve.

16. A method of allowing bi-directional flow in reciprocating screw injection molding machines having a barrel and screw which rotates in the barrel comprising the steps of:
moving the screw in a rotational direction to allow material to flow in a first axial direction;
moving the screw in a second axial direction to lock a check valve;
moving the screw in the first axial direction to cause the material to flow in the second axial direction; and
moving the screw in the rotational direction to unlock the check valve and allow material to flow in the first axial direction.

17. The method according to claim 16 wherein the second, third, and fourth moving steps are repeated a plurality of times.

18. A method of cleaning reciprocating screw injection molding machines having a barrel and screw which rotates in the barrel comprising the steps of:
displacing residual melt in screw flights of the screw with a cleaning compound;
accumulating a quantity of the cleaning compound ahead of the screw;
blocking an exit for the cleaning compound from the barrel;
moving the screw in a forward axial motion to cause the cleaning compound to travel back into the screw flights;
at least partially opening the exit; and
expelling the cleaning compound.

19. The method of claim 18 further comprising, after the moving step, the step of:
accumulating a quantity of the cleaning compound ahead of the screw.

20. The method of claim 19 wherein the moving and second accumulating steps are repeated a plurality of times.
